(19) United States
(12) Patent Application Publication
(10) Pub. No.: US 2021/0155079 A1
(43) Pub. Date: May 27, 2021

(54) DISPLAY DEVICE AND COMPUTER-READABLE STORAGE MEDIUM

(71) Applicant: TOYOTA JIDOSHA KABUSHIKI KAISHA, Aichi-ken (JP)

(72) Inventor: Yushiro ONO, Toyota-shi (JP)

(21) Appl. No.: 17/088,588

(22) Filed: Nov. 4, 2020

(30) Foreign Application Priority Data
Nov. 22, 2019 (JP) 2019-211619

(51) Int. Cl. B60H 1/00; B60K 35/00; G06F 3/0488; G06F 3/0482; G06F 3/16

(52) U.S. Cl. CPC B60H 1/00985; B60K 35/00; G06F 3/04883; B60K 2370/119; G06F 3/16; B60K 2370/1438; B60K 2370/148; G06F 3/0482

(57) ABSTRACT

An air conditioning control ECU functions as a display control section and a prohibiting section. The display control section is configured to display an icon on a touch screen in cases in which an input operation has been performed using a virtual key displayed on the touch screen or a rotary switch provided to the touch screen, the icon corresponding to an instruction arising from the input operation using the switchover key or the rotary switch. The prohibiting section is configured to prohibit display of the icon by the display control section in cases in which a specific condition has been satisfied, for example when an image captured by a camera is being displayed on the touch screen.

### CROSS-REFERENCE TO RELATED APPLICATION

This application is based on and claims priority under 35 USC 119 from Japanese Patent Application No. 2019-211619 filed on Nov. 22, 2019, the disclosure of which is incorporated by reference herein.

### BACKGROUND

### Technical Field

The present disclosure relates to a display device and a computer-readable storage medium stored with a display program.

### Related Art

Japanese Patent Application Laid-Open (JP-A) No. 2017-215623 (Patent Document 1) discloses technology in which, in response to consecutive touch operations on a keyboard displayed on a touch screen, a character string corresponding to the keys that have been touch-operated thus far is displayed in the vicinities of the respective touch-operated keys.

In the technology of Patent Document 1, a user might find the display corresponding to the touch-operated keys annoying in cases in which plural items of information are being displayed on the touch screen, in cases in which an input method other than the touch screen is being employed, and the like.

### SUMMARY

In consideration of the above circumstances, an object of the present disclosure is to obtain a display device and a computer-readable storage medium stored with a display program capable of suppressing unnecessary icon display that the user may find annoying.

A display device according to a first aspect includes a touch screen, a display control section configured to display an icon on the touch screen in cases in which an input operation has been performed using a first operation portion displayed on the touch screen or a second operation portion provided to the touch screen, the icon corresponding to an instruction arising from the input operation using the first operation portion or the second operation portion, and a prohibiting section configured to prohibit display of the icon by the display control section in cases in which a specific condition has been satisfied.

In the first aspect, examples of cases in which a specific condition has been satisfied include cases in which predetermined high priority information is being displayed on the touch screen, and cases in which an instruction equivalent to an input operation using the first operation portion or the second operation portion has been performed by an operation other than an input operation using the first operation portion or the second operation portion. In the first aspect of the present disclosure, icon display is prohibited in cases in which a specific condition is satisfied, thereby enabling unnecessary icon display that the user may find annoying to be suppressed.

A second aspect is the first aspect, wherein cases in which the specific condition has been satisfied include cases in which predetermined high priority information is being displayed on the touch screen.

In the second aspect, icon display is prohibited in cases in which the predetermined high priority information is being displayed on the touch screen, thereby enabling the user to see the high priority information more easily.

A third aspect is the second aspect, wherein the touch screen is provided inside a vehicle cabin of a vehicle, and the predetermined high priority information is an image of surroundings of the vehicle captured by an imaging section.

In the third aspect, icon display is prohibited in cases in which an image capturing the surroundings of the vehicle is being displayed on the touch screen, thereby enabling the user on board the vehicle to see the situation in the surroundings of the vehicle more easily.

A fourth aspect is of any one of the first aspect to the third aspect, wherein cases in which the specific condition has been satisfied include cases in which an instruction equivalent to an input operation using the first operation portion or the second operation portion has been performed by an operation other than the input operation using the first operation portion or the second operation portion.

In cases in which an operation other than an input operation using the first operation portion or the second operation portion has been performed, the user may be aware of the content of the instruction arising from this operation without the corresponding icon being displayed. The fourth aspect of the present disclosure thus enables unnecessary icon display that the user may find annoying to be suppressed.

A fifth aspect is the fourth aspect, wherein the operation other than the input operation using the first operation portion or the second operation portion is a speech input operation.

The fifth aspect enables icon display that the user who performed the speech input operation may find annoying to be suppressed.

A sixth aspect is the fourth aspect or the fifth aspect, wherein the operation other than the input operation using the first operation portion or the second operation portion is an input operation using a switch provided to an input device other than the touch screen.

The sixth aspect enables icon display that the user who performed the input operation using the switch provided to the input device other than the touch screen may find annoying to be suppressed.

A seventh aspect is of any one of the first aspect to the sixth aspect, wherein in cases in which an input operation is performed to move a slider that has a movable display position on the touch screen as an input operation using the first operation portion, the display control section moves the display position of the corresponding icon on the touch screen so as to follow the movement of the slider.

According to the seventh aspect, moving the display position of the icon so as to follow the movement of the slider enables the amount by which the user needs to shift their gaze in order to look at both the slider or the icon to be reduced.

An eighth aspect is of any one of the first aspect to the seventh aspect, wherein in cases in which an icon including an arrow is displayed on the touch screen, the display control section progressively shifts a display position of the arrow within the icon along a direction in which the arrow is pointing.

According to the eighth aspect, the user can be made conscious of the direction in which the arrow within the icon is pointing.

A display program stored in a computer-readable storage medium according to a ninth aspect causes a computer to execute processing, the processing including displaying an icon on a touch screen in cases in which an input operation has been performed using a first operation portion displayed on the touch screen or a second operation portion provided to the touch screen, the icon corresponding to an instruction arising from the input operation using the first operation portion or the second operation portion, and prohibiting display of the icon in cases in which a specific condition has been satisfied.

In the ninth aspect, similarly to in the first aspect, unnecessary icon display that the user may find annoying can be suppressed.

The present disclosure exhibits the advantageous effect of enabling unnecessary icon display that the user may find annoying to be suppressed.

### BRIEF DESCRIPTION OF DRAWINGS

Exemplary embodiments of the present invention will be described in detail based on the following figures, wherein:

FIG. 1 is a block diagram illustrating a schematic configuration of an onboard system according to an exemplary embodiment;

FIG. 2 is an illustration of a state in which an air conditioning operation section is displayed in a first region of a touch screen;

FIG. 3 is a functional block diagram of an air conditioning control ECU;

FIG. 4 is an illustration of a state in which an icon is displayed on a touch screen;

FIG. 5 is an illustration of a state in which an icon is displayed on a touch screen;

FIG. 6 is an illustration of a state in which an icon is displayed on a touch screen;

FIG. 7 is an illustration of a state in which an icon is displayed on a touch screen;

FIG. 8 is an illustration of a state in which an icon is displayed on a touch screen;

FIG. 9 is an illustration of a state in which an icon is displayed on a touch screen;

FIG. 10 is an illustration of a state in which an icon is displayed on a touch screen;

FIG. 11 is a flowchart illustrating air conditioning control processing;

FIG. 12 is an illustration of a state in which an image captured by a camera is displayed on a touch screen;

FIG. 13 is an illustration of a state in which a speech recognition settings screen is displayed on a touch screen;

FIG. 14 is an illustration of a state in which an emergency alert screen is displayed on a touch screen; and

FIG. 15 is an illustration of a state in which a locked screen employed for theft prevention is displayed on a touch screen.

### DETAILED DESCRIPTION

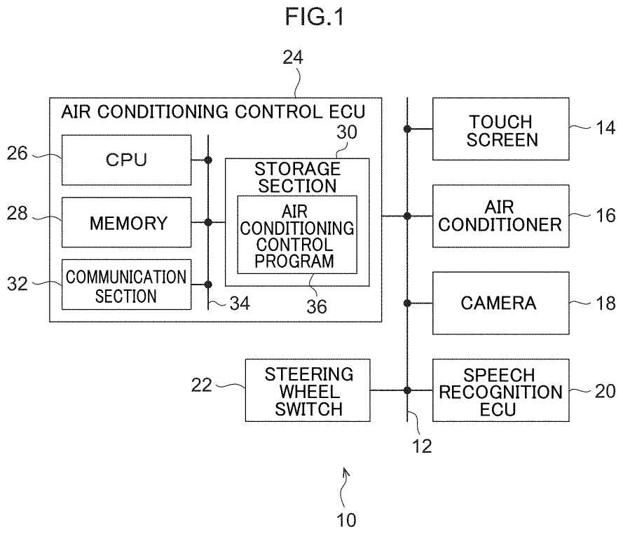

Detailed explanation follows regarding an example of an exemplary embodiment of the present disclosure, with reference to the drawings. As illustrated in FIG. 1, an onboard system 10 includes a bus 12. A touch screen 14, an air conditioner 16, a camera 18, a speech recognition electronic control unit (ECU) 20, a steering wheel switch 22, and an air conditioning control ECU 24 are respectively connected to the bus 12. Note that FIG. 1 only illustrates sections of the onboard system 10 that are relevant to the present disclosure.

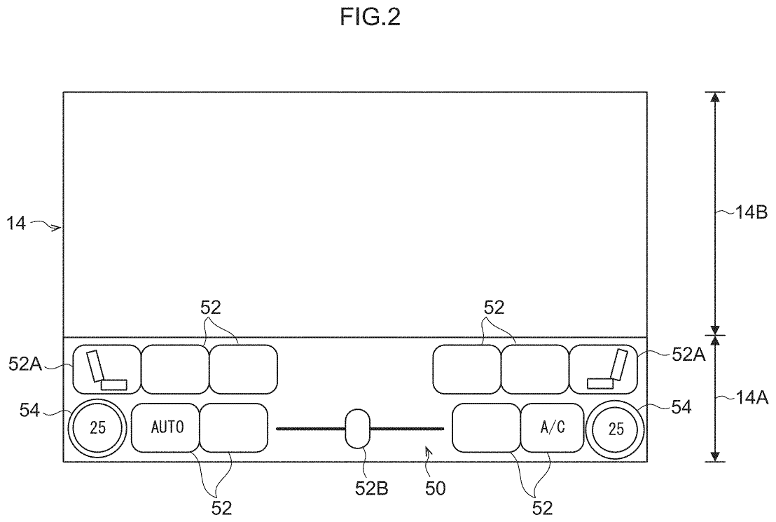

The touch screen 14 is disposed at a central portion of a vehicle instrument panel, and functions as a central display of the vehicle. As illustrated in FIG. 2, a display face of the touch screen 14 is split into a first region 14A at a vehicle vertical direction lower side and a second region 14B at a vehicle vertical direction upper side. In an ON state of an ignition switch of the vehicle, an air conditioning operation section 50 enabling input of instructions for the air conditioner 16 via the air conditioning control ECU 24 is displayed in the first region 14A.

The air conditioning operation section 50 includes plural virtual keys 52. The plural virtual keys 52 of the air conditioning operation section 50 include switchover keys 52A enabling instruction to switch between blowing modes (airflow outlets) of conditioned air by the air conditioner 16, a slider 52B enabling instruction to switch the flow rate of conditioned air by the air conditioner 16, and so on. The display position of the slider 52B on the touch screen 14 is movable. Performing an input operation to move this display position (a stroking operation on the slider 52B) enables instruction to switch the flow rate. Note that the virtual keys 52 of the air conditioning operation section 50 are an example of a first operation portion.

As illustrated in FIG. 2, rotary switches 54 are provided in the vicinity of both vehicle width direction end portions of a vehicle vertical direction lower end portion of the touch screen 14. Each of the rotary switches 54 projects out from the display surface of the touch screen 14, is capable of being rotated about an axis running along a vehicle front-rear direction, and for example enables instruction of a target temperature of the conditioned air from the air conditioner 16. Note that the rotary switches 54 are an example of a second operation portion.

The air conditioner 16 is capable of performing air conditioning independently on a driving seat side and a front passenger seat side of the vehicle. The camera 18 captures images (moving images) of the surroundings of the vehicle. Images captured by the camera 18 are displayed in the second region 14B of the touch screen 14 at predetermined timings. Examples of such predetermined timings include a timing when the vehicle performs processing to automatically park the vehicle. An image captured by the camera 18 and displayed in the second region 14B of the touch screen 14 is an example of predetermined high priority information (display). Note that the camera 18 is an example of an imaging section.

A non-illustrated microphone is connected to the speech recognition ECU 20. The speech recognition ECU 20 performs speech recognition processing to recognize speech spoken by a user on board the vehicle. In the present exemplary embodiment, the user is able to input spoken instructions for the air conditioner 16 or the like. In cases in which the recognized speech is a spoken instruction for the air conditioner 16, the speech recognition ECU 20 outputs the content of the spoken instruction to the air conditioning control ECU 24. When applying various speech recognition settings using the speech recognition ECU 20, the speech recognition ECU 20 displays a speech recognition settings screen in the second region 14B of the touch screen 14. The speech recognition settings screen displayed in the second region 14B of the touch screen 14 is an example of predetermined high priority information (display).

The steering wheel switch 22 is provided to a steering wheel of the vehicle. In the present exemplary embodiment, instructions for the air conditioner 16 can also be input by operating the steering wheel switch 22. Instructions for the air conditioner 16 that have been input through the steering wheel switch 22 are output to the air conditioning control ECU 24. The steering wheel switch 22 is an example of a switch provided to an input device other than the touch screen.

The air conditioning control ECU 24 includes a central processing unit (CPU) 26, memory 28 such as read only memory (ROM) or random access memory (RAM), a non-volatile storage section 30 such as a hard disk drive (HDD) or a solid state drive (SSD), and a communication section 32. The CPU 26, the memory 28, the storage section 30, and the communication section 32 are connected so as to be capable of communicating with each other through an internal bus 34.

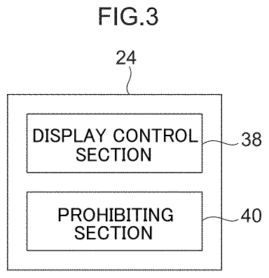

An air conditioning control program 36 is stored in the storage section 30 of the air conditioning control ECU 24. The air conditioning control ECU 24 reads the air conditioning control program 36 from the storage section 30 and expands the air conditioning control program 36 in the memory 28. The air conditioning control program 36 that has been expanded in the memory 28 is executed by the CPU 26, such that the air conditioning control ECU 24 functions as a display control section 38 and a prohibiting section 40 as illustrated in FIG. 3, and performs air conditioning control processing, described later. Note that together with the touch screen 14, the air conditioning control ECU 24 functions as an example of a display device. The air conditioning control program 36 is an example of a display program.

In cases in which an input operation is performed using one of the virtual keys 52 of the air conditioning operation section 50 displayed on the touch screen 14 or one of the rotary switches 54 provided on the touch screen 14, the display control section 38 displays an icon corresponding to an instruction arising from the input operation using the virtual key 52 or rotary switch 54 on the touch screen 14. In cases in which a specific condition, described later, is satisfied, the prohibiting section 40 prohibits the display control section 38 from displaying the icon on the touch screen 14.

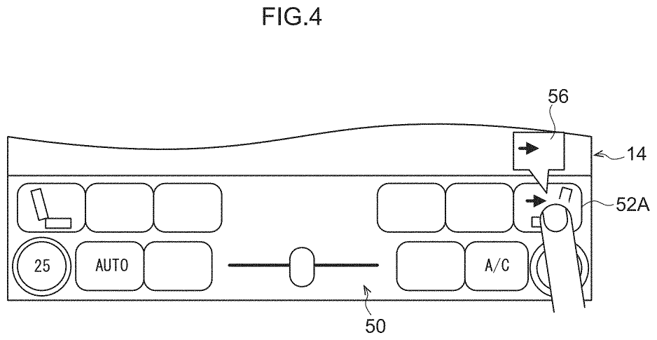

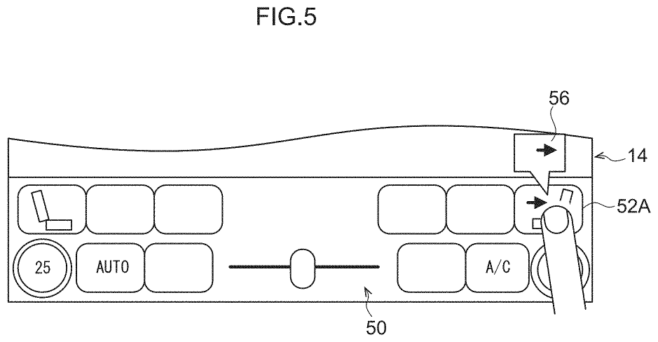

Explanation follows regarding specific examples of icon display by the display control section 38. In cases in which a touch operation has been performed using one of the switchover keys 52A of the air conditioning operation section 50 so as to switch the air conditioner 16 to a blowing mode in which a flow of air is only blown through an upper blower outlet of the air conditioner 16, the display control section 38 displays an icon 56 in the vicinity of the corresponding switchover key 52A, as illustrated in the example in FIG. 4. The icon 56 includes a single arrow indicating the flow of air through the upper blower outlet. As illustrated in the example in FIG. 5, the display control section 38 progressively shifts the display position of the arrow within the icon 56 along the direction in which the arrow is pointing while the icon 56 is being displayed on the touch screen 14.

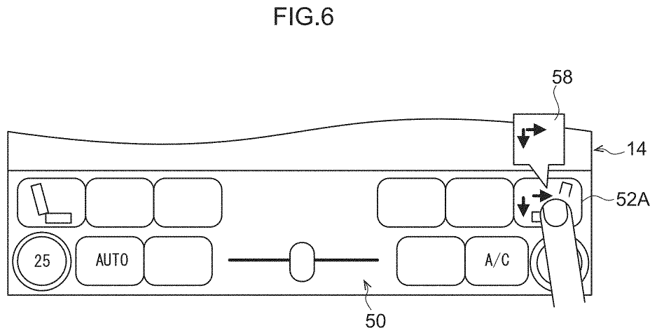

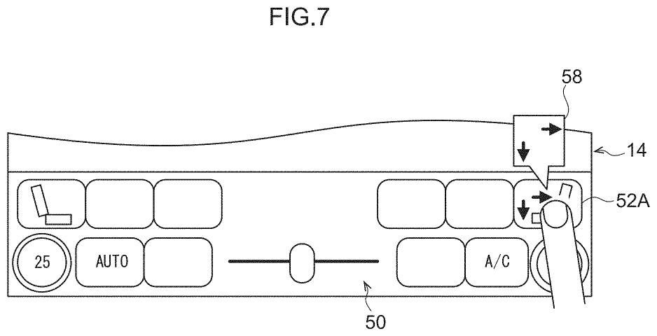

In cases in which a touch operation has been performed using one of the switchover keys 52A of the air conditioning operation section 50 so as to switch the air conditioner 16 to a blowing mode in which a flow of air is blown through both the upper blower outlet and a lower blower outlet of the air conditioner 16, the display control section 38 displays an icon 58 in the vicinity of the corresponding switchover key 52A, as illustrated in the example in FIG. 6. The icon 58 includes an arrow indicating the flow of air through the upper blower outlet and an arrow indicating the flow of air through the lower blower outlet. As illustrated in the example in FIG. 7, the display control section 38 progressively shifts the display positions of the two arrows in the icon 58 along the respective directions in which the arrows are pointing while the icon 58 is being displayed on the touch screen 14.

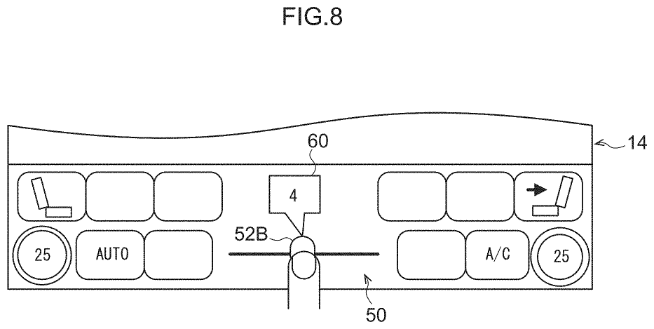

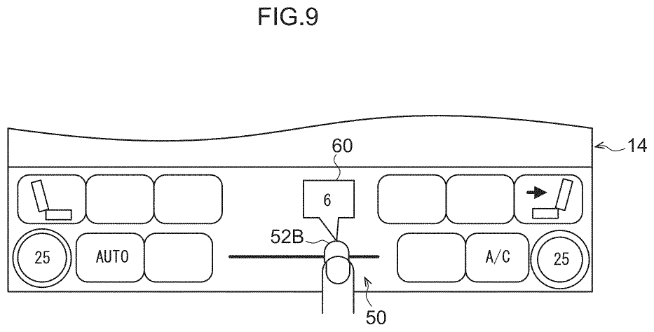

In cases in which an input operation has been performed on the slider 52B of the air conditioning operation section 50 by moving the display position of the slider 52B so as to instruct switching of the flow rate of conditioned air by the air conditioner 16, the display control section 38 displays an icon 60 in the vicinity of the slider 52B as illustrated in the example in FIG. 8. The icon 60 includes a numerical value indicating the flow rate. As illustrated in the example in FIG. 9, the display control section 38 moves the display position of the icon 60 on the touch screen 14 so as to follow the movement of the slider 52B and adjusts the numerical value indicating the flow rate within the icon 60 whenever an input operation is performed to move the display position of the slider 52B.

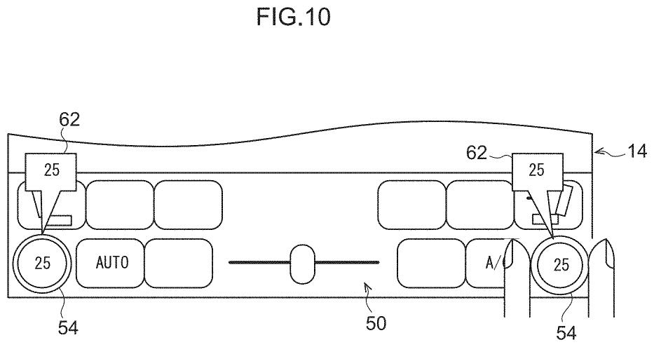

As illustrated in the example in FIG. 10, in cases in which an input operation has been performed using one of the rotary switches 54 provided to the touch screen 14 by rotating the corresponding rotary switch 54 so as to instruct changing of the target temperature of conditioned air by the air conditioner 16, the display control section 38 displays an icon 62 in the vicinity of the rotary switch 54. The icon 62 includes a numerical value indicating the target temperature. The display control section 38 adjusts the numerical value indicating the target temperature within the icon 62 whenever an input operation is performed to rotate the rotary switch 54.

Note that icons 62 corresponding to the left and right rotary switches 54 provided on the touch screen 14 are respectively displayed in FIG. 10. In cases in which the air conditioner 16 has been set to a driving state in which the air conditioning is synchronized between the driving seat side and the front passenger seat side of the vehicle, a left and right pair of the corresponding icons are displayed when an input operation is performed using one of the virtual keys 52 or one of rotary switches 54, as illustrated in FIG. 10.

The icons 56 illustrated in FIG. 4 and FIG. 5, the icons 58 illustrated in FIG. 6 and FIG. 7, the icons 60 illustrated in FIG. 8 and FIG. 9, and the icons 62 illustrated in FIG. 10 are merely examples of icons displayed by the display control section 38. Namely, the display control section 38 also displays icons on the touch screen 14 when input operations are performed on virtual keys 52 other than the switchover keys 52A and the slider 52B of the air conditioning operation section 50.

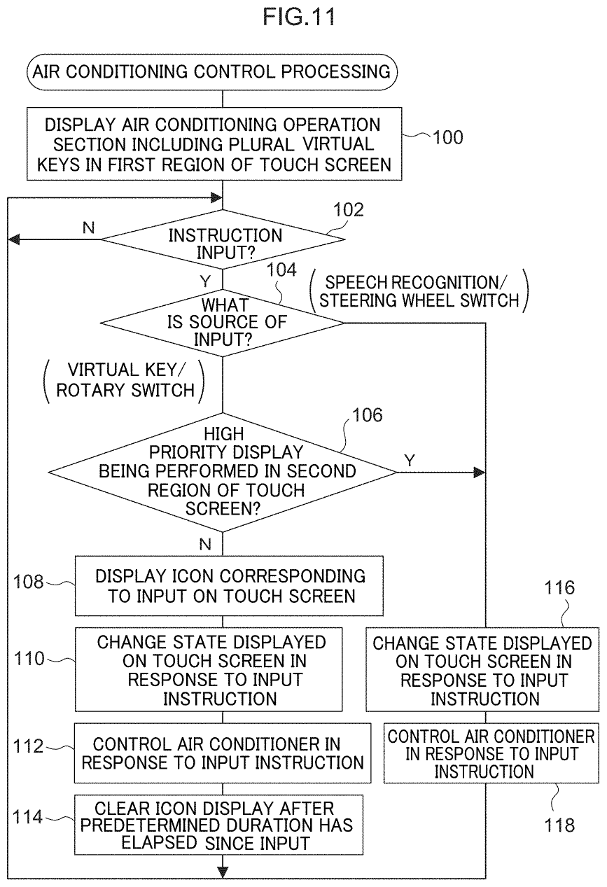

Next, as operation of the present exemplary embodiment, explanation follows regarding air conditioning control processing executed by the air conditioning control ECU 24 while the ignition switch of the vehicle is on, with reference to FIG. 11.

At step 100 of the air conditioning control processing, the display control section 38 displays the air conditioning operation section 50 including the plural virtual keys 52 in the first region 14A of the touch screen 14. At the next step 102, the prohibiting section 40 determines whether or not an instruction for the air conditioner 16 has been input. The processing of step 102 is repeated in cases in which negative determination is made at step 102. Affirmative determination is made at step 102 and processing transitions to step 104 in cases in which an instruction for the air conditioner 16 has been input.

At step 104, the prohibiting section 40 determines the source of the input instruction for the air conditioner 16, and the processing branches according to the input source of the instruction for the air conditioner 16. Processing transitions from step 104 to step 106 in cases in which the instruction for the air conditioner 16 was input by an input operation using one of the virtual keys 52 or the rotary switches 54.

At step 106, the prohibiting section 40 determines whether or not a high priority display is being performed in the second region 14B of the touch screen 14. Processing transitions to step 108 in cases in which a negative determination is made at step 106.

At step 108, the display control section 38 displays an icon (for example one out of the icons 56, 58, 60, and 62 described previously) corresponding to the input operation using the corresponding virtual key 52 or rotary switch 54 on the touch screen 14. The user is thereby able to check the content of the instruction for the air conditioner 16 as a result of their input operation by looking at the icon displayed on the touch screen 14.

At step 110, the display control section 38 changes the air conditioning state displayed on the touch screen 14 in response to the input instruction so as to make the user aware of the changed air conditioning state. For example, in cases in which a touch operation has been performed using one of the switchover keys 52A of the air conditioning operation section 50 so as to switch between blowing modes of the air conditioner 16, the display control section 38 changes the icon displayed in the vicinity of the corresponding switchover key 52A to an icon corresponding to the blowing mode of the air conditioner 16 after switching.

At step 112, the display control section 38 controls the action of the air conditioner 16 in response to the input instruction. At step 114, after a predetermined duration has elapsed since input of the instruction for the air conditioner 16, the display control section 38 clears the icon displayed on the touch screen 14 at step 108. Processing returns to step 102 after the processing of step 114 has been performed.

Processing transitions from step 104 to step 116 in cases in which the instruction for the air conditioner 16 is determined to have been input by performing a speech input operation or an input operation using the steering wheel switch 22 at step 104 (corresponding to examples of an instruction equivalent to an input operation using one of the virtual keys 52 or the rotary switches 54). Cases in which a speech input operation or an input operation using the steering wheel switch 22 has been performed are examples of cases in which a specific condition has been satisfied.

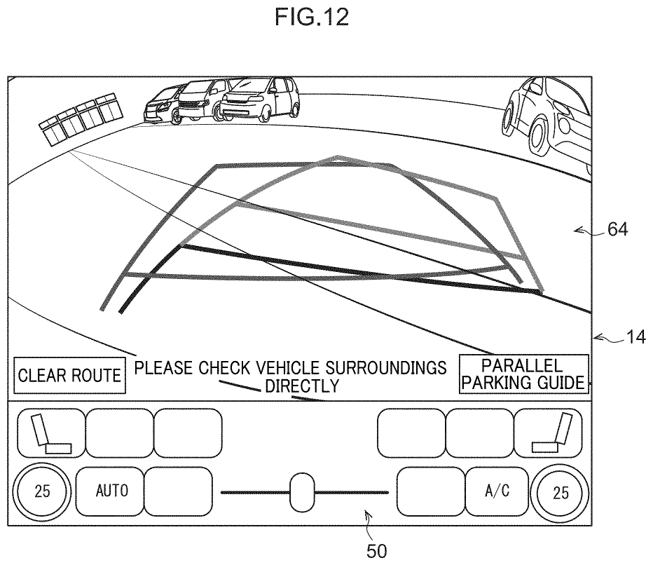

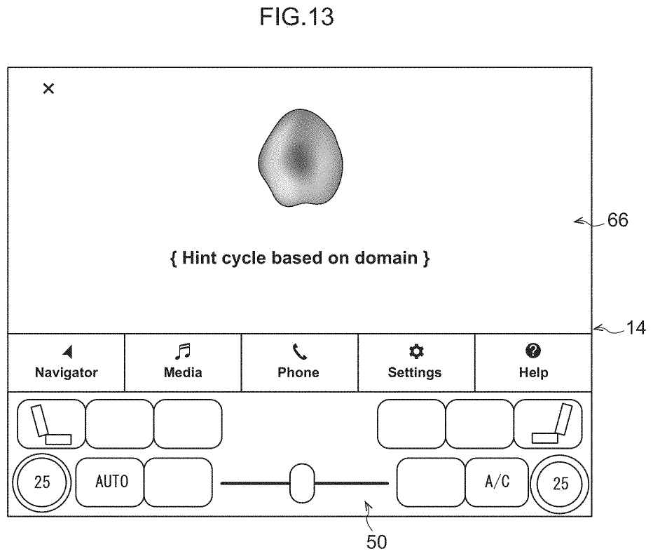

Processing transitions from step 106 to step 116 in cases in which determination is made at step 106 that a high priority display is being performed, for example in cases in which an image 64 captured by the camera 18 is being displayed in the second region 14B of the touch screen 14 as illustrated in the example in FIG. 12, and cases in which a speech recognition settings screen 66 is being displayed in the second region 14B of the touch screen 14 as illustrated in the example in FIG. 13. Cases in which a high priority display is being performed in the second region 14B of the touch screen 14 are examples of cases in which a specific condition has been satisfied.

At step 116, the display control section 38 changes the air conditioning state displayed on the touch screen 14 in response to the input instruction so as to make the user aware of the changed air conditioning state, similarly to at step 110 described previously. At step 118, the display control section 38 controls the action of the air conditioner 16 in response to the input instruction, similarly to at step 112 described previously. Processing returns to step 102 after the processing of step 118 has been performed.

In this manner, icon display on the touch screen 14 by the display control section 38 is prohibited in cases in which the instruction for the air conditioner 16 is input by performing a speech input operation or an input operation using the steering wheel switch 22. Icon display on the touch screen 14 by the display control section 38 is also prohibited in cases in which a high priority display is being performed in the second region 14B of the touch screen 14.

As described above, the touch screen 14 is provided in the present exemplary embodiment. In cases in which an input operation has been performed using one of the virtual keys 52 displayed on the touch screen 14 or one of the rotary switches 54 provided to the touch screen 14, the display control section 38 displays the icon corresponding to the instruction arising from the input operation using the corresponding virtual key 52 or rotary switch 54 on the touch screen 14. The prohibiting section 40 prohibits icon display by the display control section 38 in cases in which a specific condition is satisfied. Prohibiting icon display in cases in which a specific condition is satisfied in this manner enables unnecessary icon display that the user may find annoying to be suppressed.

In the present exemplary embodiment, cases in which a specific condition has been satisfied include cases in which predetermined high priority information is being displayed on the touch screen 14. Thus, prohibiting icon display in cases in which predetermined high priority information is being displayed on the touch screen 14 enables the high priority information to be seen more easily by the user.

In the present exemplary embodiment, the touch screen 14 is provided inside the vehicle cabin of the vehicle, and the predetermined high priority information is an image of the surroundings of the vehicle captured by the camera 18. Thus, prohibiting icon display in cases in which an image capturing the surroundings of the vehicle is being displayed on the touch screen 14 enables the situation in the surroundings of the vehicle to be seen more easily by the user on board the vehicle.

In the present exemplary embodiment, cases in which a specific condition has been satisfied include cases in which an instruction equivalent to an input operation using one of the virtual keys 52 or the rotary switches 54 has been performed by an operation other than an input operation using one of the virtual keys 52 or the rotary switches 54. In cases in which an operation has been performed by an operation other than an input operation using one of the virtual keys 52 or the rotary switches 54, the user may be aware of the content of the instruction arising from this operation without the corresponding icon being displayed. Unnecessary icon display that the user may find annoying can accordingly be suppressed.

In the present exemplary embodiment, one operation other than an input operation using one of the virtual keys 52 or the rotary switches 54 is a speech input operation. Icon display that the user who performed the speech input operation may find annoying can accordingly be suppressed.

In the present exemplary embodiment, one operation other than an input operation using one of the virtual keys 52 or the rotary switches 54 is an input operation using a switch provided to an input device other than the touch screen 14. Icon display that the user who performed the input operation using the switch provided to an input device other than the touch screen 14 may find annoying can accordingly be suppressed.

In the present exemplary embodiment, in cases in which an input operation using one of the virtual keys 52 is an input operation to move the slider 52B that has a movable display position on the touch screen 14, the display control section 38 moves the display position of the corresponding icon on the touch screen 14 so as to follow the movement of the slider 52B. By moving the display position of the icon so as to follow the movement of the slider 52B, the amount by which the user needs to shift their gaze in order to look at the slider 52B or the icon can be reduced.

In the present exemplary embodiment, in cases in which an icon including an arrow is displayed on the touch screen 14, the display control section 38 progressively shifts the display position of the arrow within the icon along the direction in which the arrow is pointing. This enables the user to be made conscious of the direction in which the arrow within the icon is pointing.

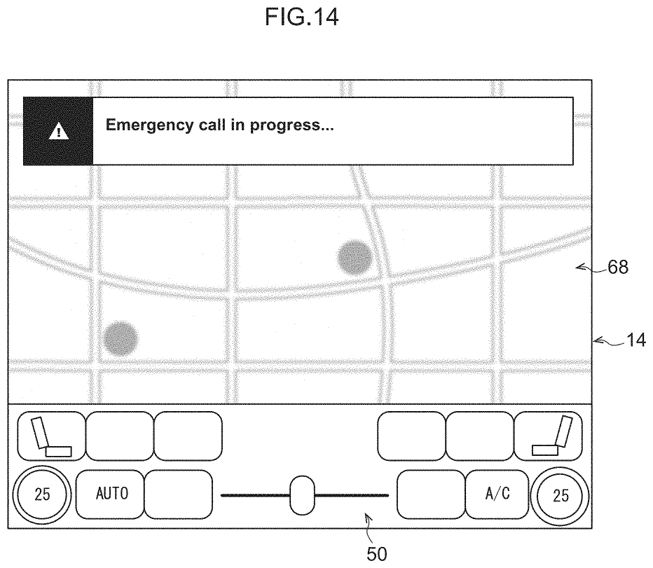

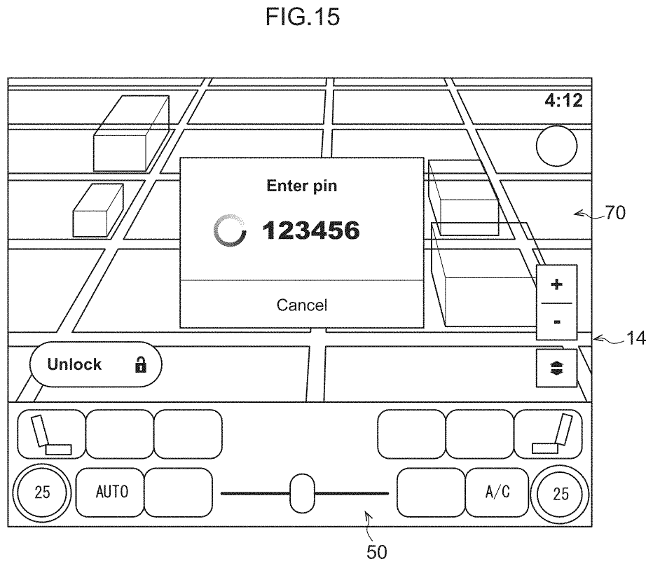

In the above description, the image 64 captured by the camera 18 (FIG. 12) and the speech recognition settings screen 66 (FIG. 13) have been explained as examples of high priority display during which icon display on the touch screen 14 is prohibited. However, high priority display is not limited thereto. For example, the high priority display may be an emergency alert screen 68 to warn that an emergency situation has arisen as illustrated in FIG. 14, or a locked screen 70 employed for theft prevention as illustrated in FIG. 15.

In the above description, the steering wheel switch 22 has been explained as an example of a switch provided to an input device other than the touch screen 14. However, there is no limitation thereto, and such a switch may be provided to the instrument panel or the like.

In the above description, an embodiment has been explained in which the air conditioning operation section 50 is displayed in the first region 14A of the touch screen 14, and the air conditioning control ECU 24 that controls the action of the air conditioner 16 functions as the display control section 38 and the prohibiting section 40 of the display device. However, there is no limitation thereto. For example, an audio operation screen may be displayed on the touch screen 14, and an audio control ECU that controls the action of audio equipment in response to input operations to the audio operation screen or the like may be made to function as the display control section 38 and the prohibiting section 40.

In the above description, an embodiment has been explained in which the touch screen 14 is disposed at the central portion of the vehicle instrument panel. However, there is no limitation thereto. For example, the touch screen 14 may be configured by a display section such as a smartphone or a tablet, and a CPU embedded in the smartphone or tablet may be made to function as the display control section 38 and the prohibiting section 40.

In the above description, an embodiment has been explained in which the air conditioning control program 36, serving as an example of a display program according to the present disclosure, is pre-stored (installed) in the storage section 30. However, the display program according to the present disclosure may be provided in a format recorded onto a recording medium such as a CD-ROM or a DVD-ROM.

What is claimed is:

1. A display device comprising:
a touch screen;
a processor configured to display an icon on the touch screen in cases in which an input operation has been performed using a first operation portion displayed on the touch screen or a second operation portion provided to the touch screen, the icon corresponding to an instruction arising from the input operation using the first operation portion or the second operation portion, and the processor being configured to prohibit display of the icon by the display control section in cases in which a specific condition has been satisfied.

2. The display device of claim 1, wherein cases in which the specific condition has been satisfied include cases in which predetermined high priority information is being displayed on the touch screen.

3. The display device of claim 2, wherein:
the touch screen is provided inside a vehicle cabin of a vehicle; and
the predetermined high priority information is an image of surroundings of the vehicle captured by a camera.

4. The display device of claim 1, wherein:
cases in which the specific condition has been satisfied include cases in which an instruction equivalent to an input operation using the first operation portion or the second operation portion has been performed by an operation other than the input operation using the first operation portion or the second operation portion.

5. The display device of claim 4, wherein the operation other than the input operation using the first operation portion or the second operation portion is a speech input operation.

6. The display device of claim 4, wherein the operation other than the input operation using the first operation portion or the second operation portion is an input operation using a switch provided to an input device other than the touch screen.

7. The display device of claim 5, wherein the operation other than the input operation using the first operation portion or the second operation portion is an input operation using a switch provided to an input device other than the touch screen.

8. The display device of claim 1, wherein:
in cases in which an input operation is performed to move a slider that has a movable display position on the touch screen as an input operation using the first operation portion, the processor moves the display position of the corresponding icon on the touch screen so as to follow the movement of the slider.

9. The display device of claim 2, wherein:
in cases in which an input operation is performed to move a slider that has a movable display position on the touch screen as an input operation using the first operation portion, the processor moves the display position of the corresponding icon on the touch screen so as to follow the movement of the slider.

10. The display device of claim 1, wherein:
in cases in which an icon including an arrow is displayed on the touch screen, the processor progressively shifts a display position of the arrow within the icon along a direction in which the arrow is pointing.

11. The display device of claim 2, wherein:
in cases in which an icon including an arrow is displayed on the touch screen, the processor progressively shifts a display position of the arrow within the icon along a direction in which the arrow is pointing.

12. The display device of claim 1, wherein:
the first operation portion comprises at least one virtual key displayed on the touch screen.

13. The display device of claim 2, wherein:
the first operation portion comprises at least one virtual key displayed on the touch screen.

14. The display device of claim 1, wherein:
the second operation portion comprises at least one rotary switch provided on the touch screen.

15. The display device of claim 2, wherein:
the second operation portion comprises at least one rotary switch provided on the touch screen.

16. A non-transitory computer-readable storage medium stored with a display program to cause a computer to execute processing, the processing comprising:
displaying an icon on a touch screen in cases in which an input operation has been performed using a first operation portion displayed on the touch screen or a second operation portion provided to the touch screen, the icon corresponding to an instruction arising from the input operation using the first operation portion or the second operation portion; and
prohibiting display of the icon in cases in which a specific condition has been satisfied.
